(19) United States
(12) Patent Application Publication
(10) Pub. No.: US 2021/0200782 A1
(43) Pub. Date: Jul. 1, 2021

(54) Creating and Performing Transforms for Indexed Data on a Continuous Basis

(71) Applicant: Elasticsearch B.V., Mountain View, CA (US)

(72) Inventors: Stephen Dodson, London (GB); Hendrik Muhs, Munich (DE)

(21) Appl. No.: 16/730,097

(22) Filed: Dec. 30, 2019

(51) Int. Cl. G06F 16/25; G06F 3/0482; G06F 16/245; G06F 9/54; G06F 16/23

(52) U.S. Cl. CPC G06F 16/258; G06F 3/0482; G06F 16/2379; G06F 9/54; G06F 16/245

(57) ABSTRACT

Creating and performing transforms for indexed data on a continuous basis. An example method includes receiving from a user a selection of a source index, the source index comprising data including a collection of documents; receiving from the user a selection of one or more fields; creating a transform of the source index based at least on the selected one or more fields; and updating the transform based at least on the selected one or more fields on a continuous basis in response to new data being ingested into the source index. The example method further includes performing the transform, comprising automatically causing display of a visual representation of the transformed source index on a computer device of the user; and automatically storing the transformed source index to a destination index. Transforms can be used to pivot a user's indexed data into a new entity-centric index.

### FIELD

The present technology pertains in general to indexed data, and more specifically, to creating and performing transforms for indexed data on a continuous basis.

### SUMMARY

This summary is provided to introduce a selection of concepts in a simplified form that are further described in the Detailed Description below. This summary is not intended to identify key or essential features of the claimed subject matter, nor is it intended to be used as an aid in determining the scope of the claimed subject matter.

The present disclosure provides various embodiments of systems and methods for creating and performing transforms for indexed data on a continuous basis. An exemplary computer-implemented method includes receiving from a user a selection of a source index, the source index comprising data including a collection of documents; receiving from the user a selection of one or more fields; creating a transform of the source index based at least on the selected one or more fields; and updating the transform based at least on the selected one or more fields on a continuous basis in response to new data being ingested into the source index. The computer-implemented method may further include performing the transform, comprising automatically causing display of a visual representation of the transformed source index on a computer device of the user; and automatically storing the transformed source index to a destination index. Transforms can be used to pivot a user's indexed data into a new entity-centric index.

In various embodiments, a system is provided including a processor and a memory communicatively coupled to the processor, the memory storing instructions executable by the processor to receive from a user a selection of a source index, the source index comprising data including a collection of documents; receive from the user a selection of one or more fields; create a transform of the source index based at least on the selected one or more fields; update the transform based at least on the selected one or more fields on a continuous basis in response to new data being ingested into the source index; perform the transform, comprising: automatically causing display of a visual representation of the transformed source index on a computer device of the user; and automatically storing the transformed source index to a destination index.

In some embodiments, a non-transitory computer readable medium is provided having embodied thereon a program, the program being executable by a processor for performing a method for: receiving from a user a selection of a source index, the source index comprising data including a collection of documents; receiving from the user a selection of one or more fields; creating a transform of the source index based at least on the selected one or more fields; updating the transform based at least on the selected one or more fields on a continuous basis in response to new data being ingested into the source index; performing the transform, comprising automatically causing display of a visual representation of the transformed source index on a computer device of the user; and automatically storing the transformed source index to a destination index.

### BRIEF DESCRIPTION OF THE DRAWINGS

Embodiments are illustrated by way of example, and not by limitation, in the figures of the accompanying drawings, in which like references indicate similar elements and in which:

FIG. 1 is a simplified block diagram of a system having a distributed application structure, according to some embodiments.

FIG. 2 is an example overall diagram illustrating various aspects and process flow for an example environment for the present technology, according to example embodiments.

FIG. 3 is an example overall diagram showing various aspects within the environment in the example in FIG. 2, according to some embodiments.

FIG. 4 illustrates an example transform pivot preview for an example use case.

FIG. 5 illustrates an example graphically showing churn rate features for various customers in a histogram format, according to some embodiments.

FIG. 6 and FIG. 7 illustrate examples graphically showing a continuous pivot transform for time series data, according to some embodiments.

FIG. 8 illustrates an example for creating a new transform via a user interface, according to some embodiments.

FIG. 9 illustrates an example for creating a new transform via an application program interface (API), according to some embodiments.

FIG. 10 illustrates an example eCommerce transform which groups the data by customer_ID and calculates the sum of products that each customer purchased, according to some embodiments.

FIG. 11 illustrates an example transform configured by using a sum aggregation on one field, a max aggregation on another field, and the cardinality aggregation on still another field, according to some embodiments.

FIG. 12 illustrates an example of using an API for a transform to filter the data using a query term, according to some embodiments.

FIG. 13A illustrates an example user interface (UI) providing an option to choose to run the transform in continuous mode, according to some embodiments.

FIG. 13B illustrates an example UI for configuring the continuous mode, according to some embodiments.

FIG. 14 illustrates an example for the create transforms API, according to some embodiments.

FIG. 15 illustrates an example UI for exploring the composite aggregation data in the destination index, according to some embodiments.

FIG. 16 illustrates an example transform preview for an example for finding customers who spent the most in a hypothetical webshop, according to an example embodiment.

FIG. 17 illustrates an example view which provides the layout of the transform in advance, enabled by the example previews API, according to an example embodiment.

FIG. 18 illustrates an example transform preview concerning a use case regarding finding air carriers with the most delays, according to some embodiments.

FIG. 19 illustrates an example transform preview that shows a user that the new destination index can contain data values for the air carriers in the example in FIG. 18, according to some embodiments.

FIG. 20 illustrates an example transform preview concerning an example use case regarding finding suspicious client IPs by using scripted metrics, according to some embodiments.

FIG. 21 illustrates an example transform preview which can also show a user that the new destination index could contain data values for each clientip.

FIG. 22 is a flow diagram of a method, according to an example embodiment.

FIG. 23 is a simplified block diagram of a computing system, according to some embodiments.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

The present disclosure is related to various embodiments of systems and methods creating and performing transforms of indexed data on a continuous basis.

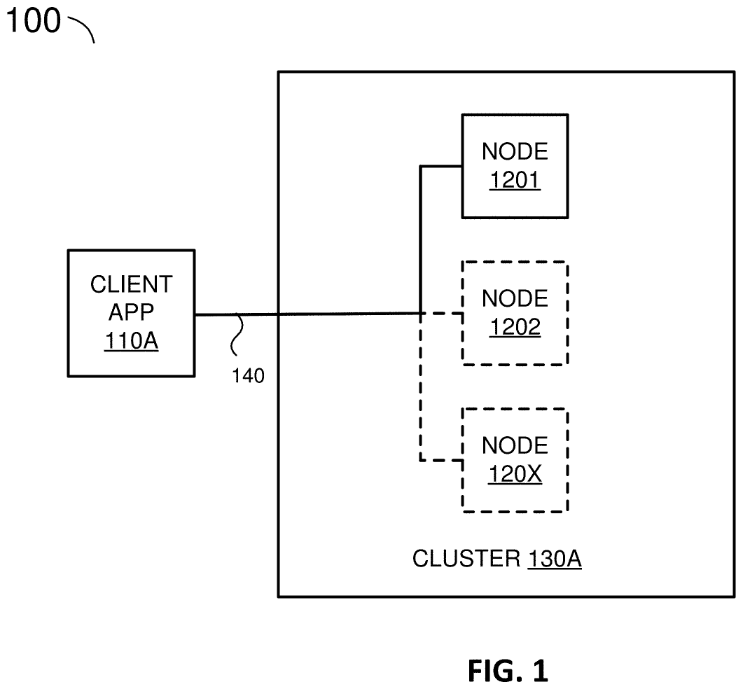

FIGS. 1-3 below describe an exemplary platform for practicing the invention and set the stage for the additional details of various embodiments described below. Although certain aspects and examples are described with respect to Elasticsearch and the Elastic Stack, it should be appreciate that the present technology is not so limited.

FIGS. 1-3 provide an overview of an example overall system and some aspects and components that may be used for some embodiments.

FIG. 1 is a simplified diagram illustrating a system 100 to illustrate certain concepts of the distributed nature and distributed application structure, according to some embodiments. System 100 includes client application 110A, one or more nodes 1201-120X, and connections 140. Collectively, one or more nodes 1201-120X form cluster 130A. When only one node (e.g., node 1201) is running, then cluster 130A is just one node. In various embodiments, a cluster (e.g., cluster 130A) is a collection of one or more nodes (servers) (e.g., one or more nodes 1201-120X) that together store data and provides federated indexing and search capabilities across all nodes. A cluster can be identified by a unique name, such that a node can be part of a cluster when the node is set up to join the cluster by its name. A cluster may have only one node in it. In some embodiments, a node (e.g., one or more nodes 1201-120X) is a single server that is part of a cluster (e.g., cluster 130A), stores data, and participates in the cluster's indexing and search capabilities. A node can be identified by a name which by default is a random Universally Unique IDentifier (UUID) that is assigned to the node at startup. Any number of nodes can be in a single cluster. In some embodiments, nodes (e.g., one or more nodes 1201-120X) can communicate using an application protocol (e.g., Hypertext Transfer Protocol (HTTP), transport layer protocol (e.g., Transmission Control Protocol (TCP)), and the like. Nodes can know about all the other nodes in the cluster (e.g., cluster 130A) and can forward client (e.g., client 110A) requests to the appropriate node. Each node can serve one or more purposes, master node and data node.

An index (not depicted in FIG. 1) is a collection of documents that have somewhat similar characteristics, according to various embodiments. For example, you can have an index for customer data, another index for a product catalog, and yet another index for order data. An index is identified by a name and this name is used to refer to the index when performing indexing, search, update, and delete operations against the documents in it. A document (not depicted in FIG. 1) is a basic unit of information that can be indexed, according to some embodiments. For example, you can have a document for a single customer, another document for a single product, and yet another for a single order. An index can potentially store a large amount of data that can exceed the hardware limits of a single node. For example, a single index of a billion documents taking up 1 TB of disk space may not fit on the disk of a single node or may be too slow to serve search requests from a single node alone. An index can be subdivided into multiple pieces called shards. Each shard can be a fully-functional and independent “index” that can be hosted on any node (e.g., one or more nodes 120₁-120_{X}) in the cluster.

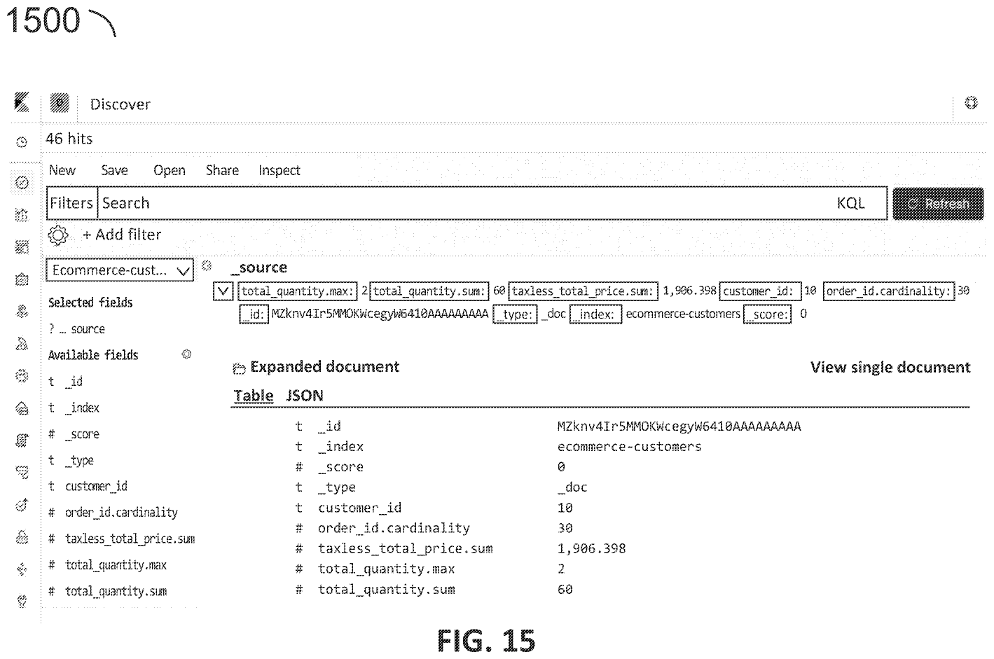

Each of client application 110A and one or more nodes 1201-120X can be a container, physical computing system, virtual machine, and the like. Generally, client application 110A can run on the same or different physical computing system, virtual machine, container, and the like as each of one or more nodes 1201-120X. Each of one or more nodes 1201-120X can run on the same or different physical computing system, virtual machine, container, and the like as the others of one or more nodes 1201-120X. A physical computing system is described further in relation to the exemplary computer system 1500 of FIG. 15. Virtual machines may provide a substitute for a physical computing system and the functionality needed to execute entire operating systems.

When client application 110A runs on a different physical server from a node (e.g., of one or more nodes 1201-120X), connections 140 can be a data communications network (e.g., various combinations and permutations of wired and wireless networks such as the Internet, local area networks (LAN), metropolitan area networks (MAN), wide area networks (WAN), and the like using Ethernet, Wi-Fi, cellular networks, and the like). When a node (of one or more nodes 1201-120X) runs on a different physical computing system from another node (of one or more nodes 1201-120X), connections 140 can be a data communications network. Further details regarding the distributed application structure can be found in commonly assigned U.S. patent application Ser. No. 16/047,959, filed Jul. 27, 2018 and incorporated by reference herein.

Having provided the above details of certain concepts of the distributed application structure described above, the description now turns to further aspects of various components on an example platform that could be used for practicing the present technology, according to various embodiments.

Although various example embodiments are described herein with respect to KIBANA and other elements of an integration solution called ELASTIC STACK, the present technology is not so limited.

KIBANA provides for data visualization and exploration, for example, for log and time-series data analytics, application monitoring, and other use cases regarding a user's data on its servers, cloud-based services used, etc.

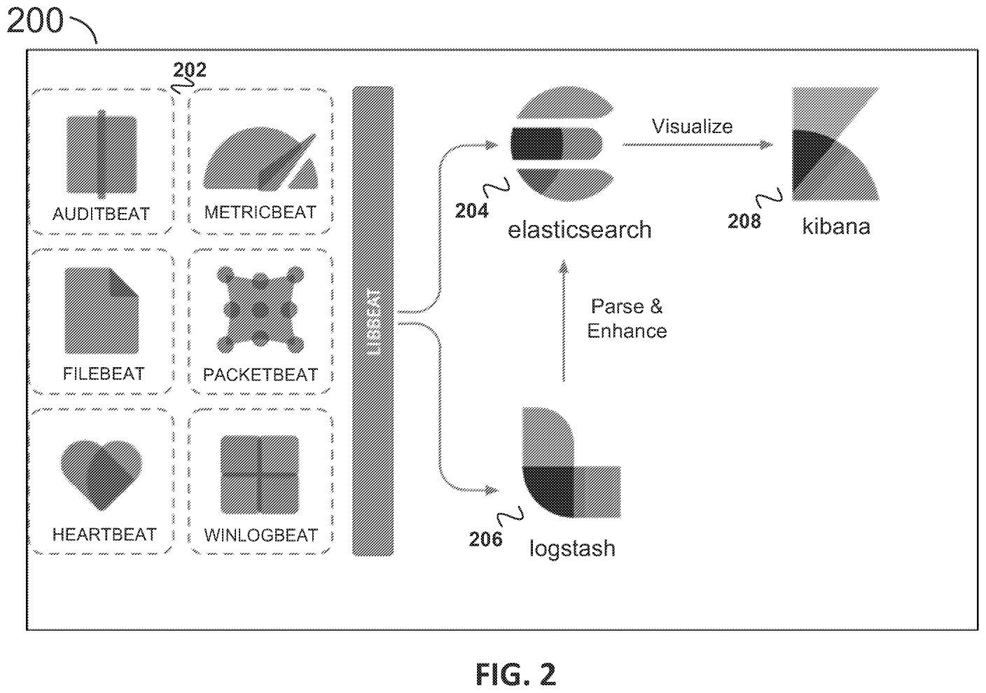

FIG. 2 is an example diagram of a system 200 illustrating KIBANA connections and flow with respect to other aspects of an integrated solution referred to as ELASTIC STACK. BEATS 202 can capture various items including but not limited to audit data (AUDITBEAT), log files (FILEBEAT), availability (HEARTBEAT), metrics (METRICBEAT), network traffic (PACKETBEAT), and windows event logs (WINLOGBEAT). Although each of those is shown in FIG. 2, BEATS need not include all of those elements in this example. BEATS can send data directly into ELASTICSEARCH 204 or via LOGSTASH 206 (a data-collection and log-parsing engine) where it can be further processed and enhanced before visualizing, analyzing and exploring it using KIBANA 208). Although FIG. 2 includes KIBANA 208 and other particular aspects and components, the present technology is not limited to utilizing some or all of the components and aspects.

KIBANA 208 can provide a powerful and easy-to-use visual interface with features such as histograms, line graphs, pie charts, sunbursts that can be caused to be displayed, and can enable a user to design their own visualization, e.g., leveraging the full aggregation capabilities of the ELASTICSEARCH 204 (a distributed, multitenant-capable full-text analytics and search engine). In that regard, KIBANA 208 can provide tight integration with ELASTICSEARCH 204 for visualizing data stored in ELASTICSEARCH 204. KIBANA 208 may also leverage the Elastic Maps Service to visualize geospatial data, or get creative and visualize custom location data on a schematic of the user's choosing. Regarding time series data, KIBANA 208 can also perform advanced time series analysis on a company or other user's ELASTICSEARCH 204 data with provide curated time series user interfaces (UI)s. Queries, transformations, and visualizations can be described with powerful, easy-to-learn expressions. Relationships can be analyzed with graph exploration.

With KIBANA 208, a user may take the relevance capabilities of a search engine, combine them with graph exploration, and uncover the uncommonly common relationships in the user's ELASTICSEARCH 204 data. In addition, KIBANA 208 can enable a user to detect the anomalies hiding in a user's ELASTICSEARCH 204 data and explore the properties that significantly influence them with unsupervised machine learning features. A user could also, e.g., using CANVAS, infuse their style and creativity into presenting the story of their data, including live data, with the logos, colors, and design elements that make their brand unique. This covers just an exemplary subset of the capabilities of KIBANA 208.

It can be provided for the user to share visualizations and dashboards (e.g., KIBANA 208 or other visualizations and dashboards) within a space or spaces (e.g., using KIBANA SPACES), with others, e.g., a user's team members, the user's boss, their boss, a user's customers, compliance managers, contractors, while having access controlled.

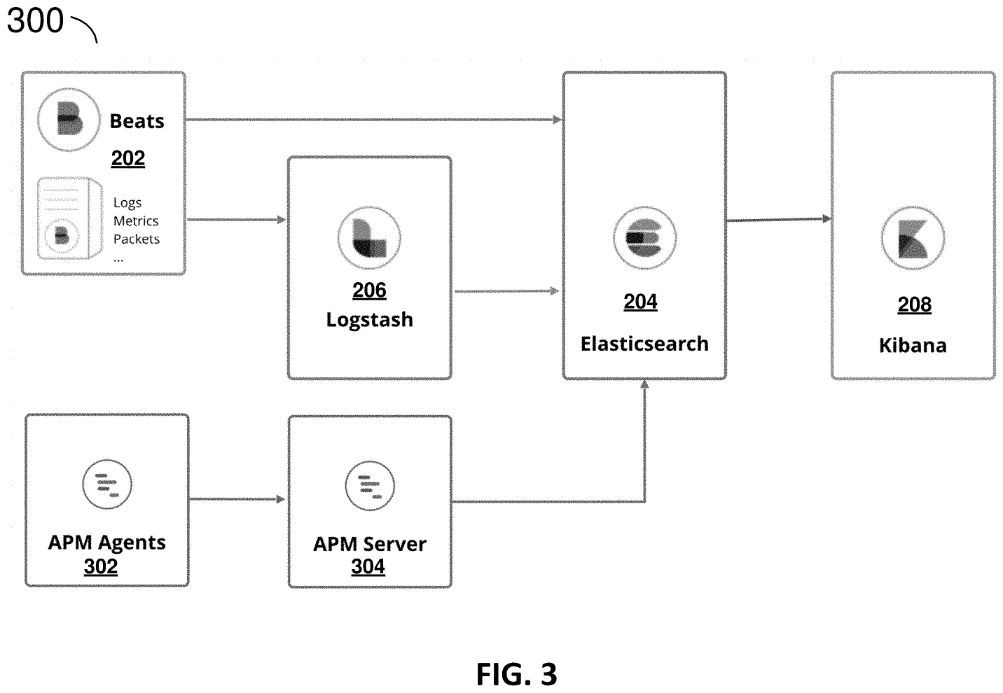

FIG. 3 is an example overall diagram 300 showing various application performance monitoring (APM) aspects within the environment in the example in FIG. 2, according to some embodiments. In the example in FIG. 3, a plurality of APM agents 302 are included. In various embodiments, the APM agents are open source libraries written in the same language as a user's service. A user may install APM agents 302 into their service as the user would install any other library. The APM agents 302 can instrument a user's code and collect performance data and errors at runtime. In various embodiments, the collected performance data and errors (also referred to collectively as collected data or just data) is buffered for a short period and sent on to APM Server 304 304. In some embodiments, the APM Server 304 is an open source application which typically runs on dedicated servers. The APM Server 304 may receive the collected data from the APM agents 302 through an application programming interface (API). In some embodiments, the APM Server 304 creates documents from the collected data from the APM agents 302 and store the documents in the full-text search and analytics engine, e.g., ELASTICSEARCH 204 in this example. ELASTICSEARCH 204 can allow the user to store, search, and analyze big volumes of data quickly and in near real time. The documents can include APM performance metrics. As further described herein, KIBANA 208 is an open source analytics and visualization platform designed to work with ELASTICSEARCH 204. KIBANA 208 may be used to search, view, and interact with data stored in ELASTICSEARCH 204. KIBANA 208 may also be used to visualize APM data by utilizing the APM UI.

Aggregations can be a powerful and flexible tool that enables a user to summarize and retrieve complex insights about their data. A user may summarize complex things like the number of web requests per day on a busy website, broken down by geography and browser type, to list just a few examples. If a user uses the same data set to try to get insights into things that are specific to the particular user this can quickly result in a computation explosion. For example, if the user uses the same data set to calculate something as simple as a single number for the average duration of visitor web sessions concerning this particular user for all their data, this can quickly result in using all available memory resources for instance. This resource depletion may arise because a web session duration is an example of a behavioral attribute not held on any one log record; it has to be derived by finding the first and last records for each session in weblogs. This derivation can require some complex query expressions and a lot of memory resources to connect all the data points.

In various embodiments, an ongoing background process that fuses related events from one index into entity-centric summaries in another index provides a more useful, joined-up picture. In various embodiments, this new index is also referred to herein as a composite index or a transform.

Transforms have several advantages over mere aggregations. These advantages are most pronounced for certain circumstances such as the user needs a complete feature index rather than a top-N set of items; the user needs to sort aggregation results by a pipeline aggregation; and the user wants to create summary tables to optimize queries, to name just a few non-limiting examples. Regarding needing a complete feature index rather than a top-N set of items, in machine learning a user often needs a complete set of behavioral features rather just the top-N. For example, customer churn is being predicted, a user might look at features such as the number of website visits in the last week, the total number of sales, or the number of emails sent. Models for machine learning may be created based on this multi-dimensional feature space, in order to benefit from the full feature indices that are created by transforms. This scenario can also apply when a user is trying to search across the results of an aggregation or multiple aggregations. Aggregation results can be ordered or filtered, but there are various limitations to ordering (e.g., when there are many unique terms aggregation may return buckets for just the top ten terms) and filtering by bucket selector is constrained (e.g., by the maximum number of buckets returned). If a user wants to search all aggregation results and sort or filter the aggregation results by multiple fields, transforms according to various embodiments are particularly useful and advantageous.

For the scenario where the user needs to sort aggregation results by a pipeline aggregation, there would otherwise be a problem since pipeline aggregations may not be used for sorting because they are run during the reduce phase after all other aggregations have already completed. The creation of a transform can effectively perform multiple passes over the data which solves the problem, according to various embodiments.

Regarding the scenario, where the user wants to create summary tables to optimize queries, here again transforms can provide substantial benefits. For example, if a user has a high level dashboard that is accessed by a large number of users and the dashboard uses a complex aggregation over a large dataset, it may be more efficient to create a transform to cache results. In that way, each user need not need run the aggregation query.

In various embodiments, a transform is a two-dimensional tabular data structure. In the context of a search engine, e.g., a distributed, multitenant-capable full-text analytics and search engine including but not limited to Elasticsearch which may be part of an integration solution such as Elastic Stack described above), the transform is a transformation of data that is indexed in the search engine. In an example embodiments, a user can use transforms to pivot their data into a new entity-centric index. By transforming and summarizing their data in various embodiments, it becomes possible to visualize and analyze it in alternative and interesting ways.

Many of the search indices may be organized as a stream of events where each event is an individual document, for example, a single item purchase. Transforms can enable a user to summarize this data, bringing it into an organized, more analysis-friendly format. The user can for instance summarize all the purchases of a single customer.

Transforms provide for a user to define a pivot. In various embodiments, a pivot is a set of features that can transform the index into a different, more digestible format. Pivoting results in a summary of the user's data, which can also be referred to as the transform, according to various embodiments.

Various embodiments provide for defining the pivot. In a first operation, a user can select one or more fields that they will use to group their data. A user may select categorical fields (terms) and numerical fields for grouping. If numerical fields are used, the field values can be bucketed using an interval (e.g., a time interval or date interval) that the user can specify.

As a second operation, the user can decide how they want to aggregate the grouped data. When using aggregations, inquiries can be made about the index. There are different types of aggregations, each with its own purpose and output. The composite aggregations can include but are not limited to average, weighted average, cardinality, geo Centroid, max, min, scripted metric, sum, value count and bucket script, according to example embodiments.

In some embodiments, the methods and systems provide for the user to add a query to further limit the scope of the aggregation.

In various embodiments, the transform performs a composite aggregation that paginates through all the data defined by the source index query. The output of the aggregation may be stored in a destination index. Each time the transform queries the source index, it can create a checkpoint.

The user can decide whether they want the transform to run once (referred to as a batch transform) or continuously (time series or continuous transform). In various embodiments, a batch transform is a single operation that has a single checkpoint. Continuous transforms continually increment and process checkpoints as new source data is ingested.

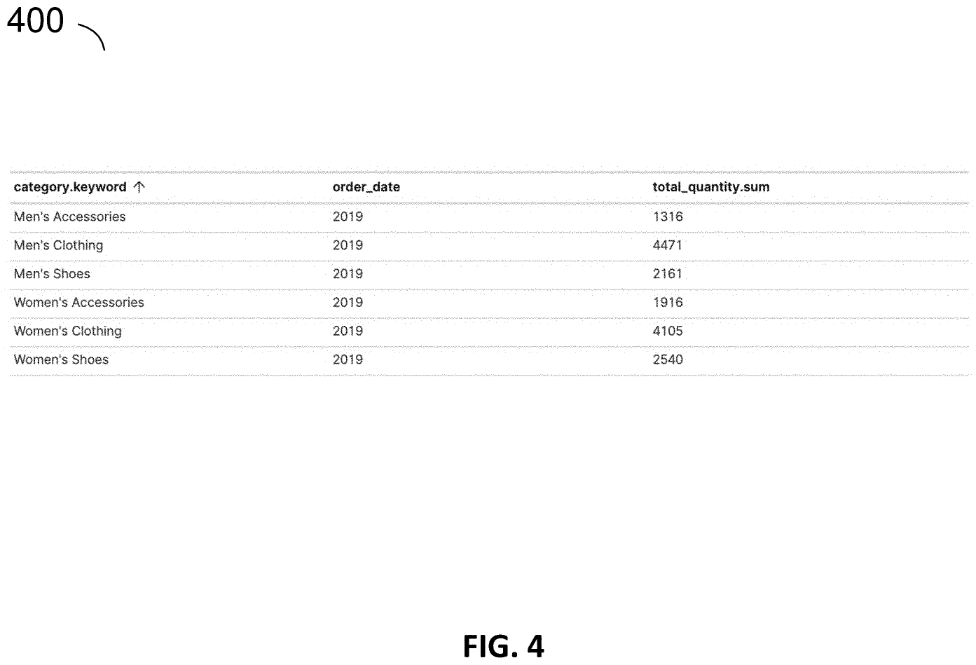

In one example, a user runs a webshop that sells clothes, shoes, and various accessories. Every order in this example creates a document that can contain a unique order ID, the name and the category of the ordered product, its price, the ordered quantity, the exact date of the order, and some customer information (e.g., name, gender, location, etc.). The dataset can contain all the transactions from last year. If the user for this example desires to get insights into the sales in the different categories in their last fiscal year, a transform can be defined that groups the data by the product categories (women's shoes, men's clothing, etc.) and the order date. The last year can be used as the interval for the order date. Then, the user can add a sum aggregation on the ordered quantity. The result is a transform that shows the number of sold items in every product category in the last year. FIG. 4 illustrates an example transform pivot preview 400 for the above webshop example.

Thus, standard aggregations can be helpful when there is a limited data set and a limited number of results. At the same time, if a user wants to do an operation across the entire dataset, the proper type of transform would yield the entire set of results otherwise unattainable with the standard aggregations.

One example use case for using transforms is machine learning. For instance a scene learning model may be created based on the behavior of a particular user or entity, then instead of just looking at and emphasizing the top behaviors (e.g., top ten behaviors) the model can instead be created using transform(s) that captures the behavior across the entire user base. For this example, a user can create an actual model that can that can fit in and perform predictions for instance on what people do not buy, or the total amount of sales metrics, number of emails, etc.

Other example use cases include using transforms to sort traits in summary tables to optimize queries. In some embodiments, if it is required to do repeated complex aggregations, a sort of pay-as-you-go model can be provided using the transform which can effectively be much more efficient to determine these aggregations across the entire data set.

In various embodiments, an application program interface (API) or a user interface can be used to instantiate a transform. The API can define a particular transform, which copies data from source indices, transforms it, and persists it into an entity-centric destination index. The entities may be defined by the set of fields in the pivot object. The destination index can be considered a two-dimensional tabular data structure. In various embodiments, the ID for each document in the data structure is generated from a hash of the entity, so there is a unique row per entity.

In response to the transform being created, a series of validations automatically occur to ensure its success, according to various embodiments. For example, a check can automatically be made to confirm the existence of the source indices and another check automatically made to confirm that the destination index is not part of the source index pattern.

In various embodiments, instantiating the transform via a user interface could utilize an analytics and visualization platform (e.g., KIBANA in some embodiments) to create the transform.

For the user interface for example, a user can select some data, group it by user session or Apache session where features of interest may be maximum timestamp and the number of distinct URLs captured then just create a transform. Options can be provided for continuous (time series data) mode or a static mode. The transform can take the data that exists in the sort at that time. Effectively in this example there is pivoting that is in a batch and creating data in this destination index. Based on that configuration there can be a nice batch transforming which is very useful if a user is doing a one-off machine learning analysis.

In some embodiments, new data is utilized such that a secondary index that is being created based on the pivot is continually updated as new data comes into the source index, e.g., training the updated transformation.

In various embodiments, the transforms function with respect to the indices for the data rather being done on the ingest stream of data. In example embodiments, using the indices means waiting for the data to become available in the indices and available for the user to query. The transform would operate in this example behind the current timestamp, which allows the search engine to have cached the data for the data to be available for querying. This can also prevent some other issues that might otherwise arise such as the out of order issues that could arise if operating directly on the ingest stream of data. In various embodiments, the data is ingest into the indices and the transform works on that data in a continuous basis but slightly behind real time and are transforming the aggregation to create the transformed image.

For example, raw log data from a system that logs the state of a transaction can be ingested into an index and continuously updated. Example log data is shown below before transformation:

{“transaction_id”:“685dc1d2”, “user”:“steve”, “state”:“start”, “timestamp”:“2019-09-27T12:26:53”}
{“transaction_id”:“685dc1d2”, “user”:“steve”, “state”:“processing”, “timestamp”:“2019-09-27T12:27:02”}
{“transaction_id”:“44b2de05”, “user”:“bill”, “state”:“start”, “timestamp”:“2019-09-27T12:27:03”}
{“transaction_id”:“685dc1d2”, “user”:“steve”, “state”:“end”, “timestamp”:“2019-09-27T12:27:06”}
{“transaction_id”:“44b2de05”, “user”:“bill”, “state”:“processing”, “timestamp”:“2019-09-27T12:27:09”}

The data in this index can be continuously transformed via pivot into a secondary index that summarizes the transaction (by transaction_id, user), e.g.:

| transaction_id | user | last_state | timestamp | duration |
|---|---|---|---|---|
| 685dc1d2 | steve | end | 2019-09-27T12:26:53 | 00:00:13 |
| 44b2de05 | bill | processing | 2019-09-27T12:27:03 | 00:00:06 |
| . . . | | | | |

This derived index can be used to summarize the state and duration of the transactions. This can be used to gain additional insights such as for example:

Show me the longest transactions (based on duration of transactions that have ended);

Show me the transactions that are ‘stuck’—e.g. not ended more than 1 hour;

Detect anomalous transactions (based on machine learning anomaly detection); and

Predict the typical duration of a transaction.

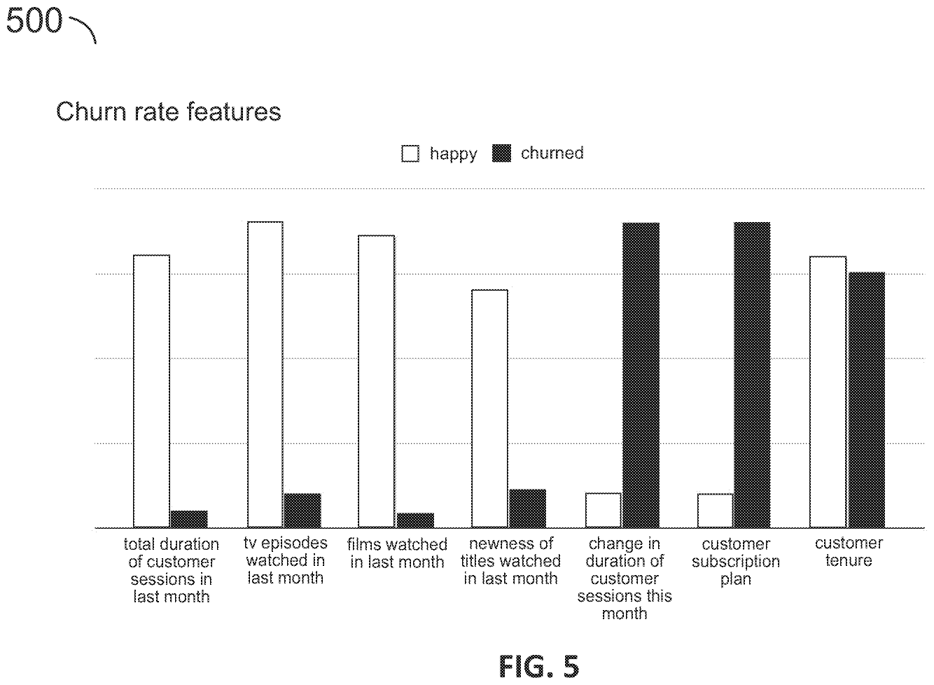

In another machine learning example of the use of transforms, the data includes records world-wide from a consumer video streaming service where there is a log message indicating that a customer (e.g., subscriber to the service) has watched something on their service. The user (affiliated with the streaming service) may wish to predict churn of such that it is desired to create a summary of a user's behavior, which requires aggregating with more and more data into a set of features. Those features can then be analyzed. FIG. 5 illustrates an example showing churn rate features 500 for happy and churned customers. If these features are being created in a continuous basis, then the user can understand on a daily basis what customers are likely to churn. In various embodiments, the transforms provide for this sort of powerful behavioral analytics and machine learning. This streaming service example may create a daily report or weekly report, whereas other example use cases, e.g., for analyzing the duration of a user session on the websites, or, more importantly, a trade transaction, are more amenable to requiring continuous or near real time reporting. For the latter example, if the trade transaction is above a certain threshold, an alert might be desired; so a more real time continuous process operating on the data in a timely fashion.

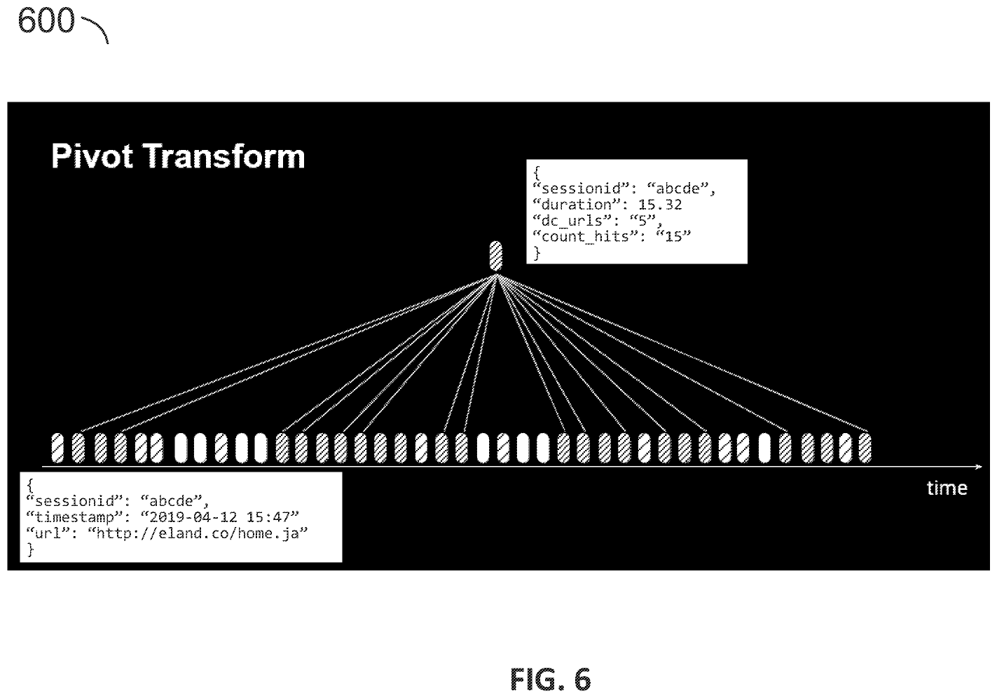

For the example use case of analyzing the duration of user sessions on websites, FIG. 6 and FIG. 7 illustrates examples graphically showing a continuous pivot transform 600 and 700 respectively for a composite aggregation of the time series data.

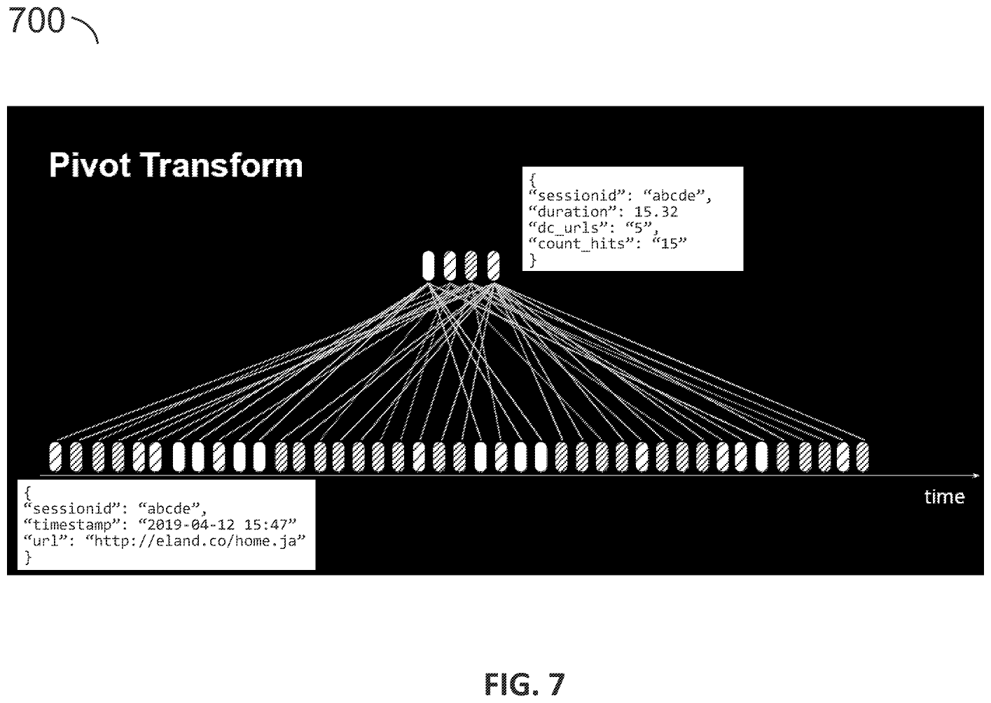

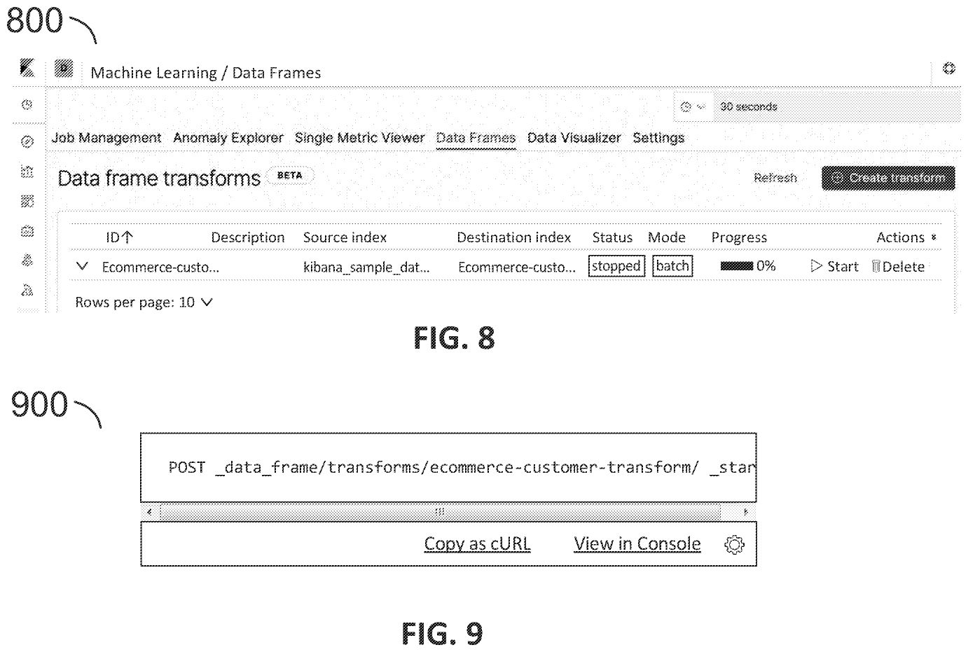

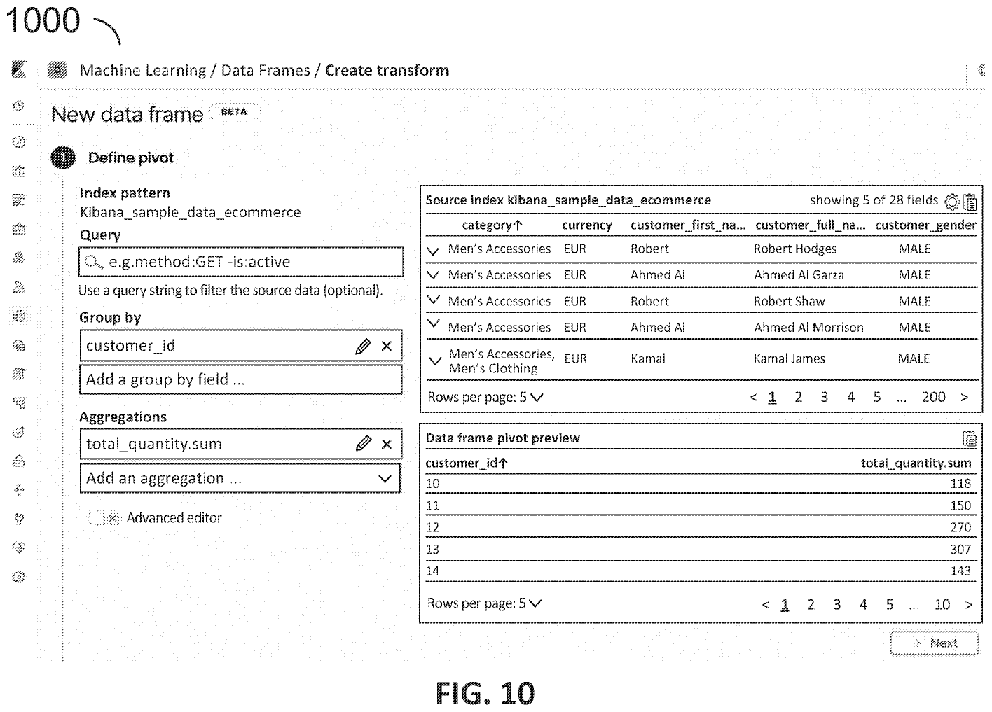

In another example use case, eCommerce data is transformed. In this example eCommerce information is retrieved from an search engine index, transformed and stored in another index. An API or UI can be used to instantiate this transform. In an example, a user interface such as KIBANA is utilized for creating this transform. FIG. 8 illustrates an example user interface 800 to start, stop and manage transforms. Alternatively, an API can be used instead of the user interface. FIG. 9 illustrates an example 900 start transforms and stop transforms API. Turning to FIG. 8, in a first operation, the source index is chosen, in this example it is referred to as the kibana_sample_data_ecommerce index identified at 802. In this example, eCommerce order sample data is used. The user can consider what insights they wish to derive from this data and try various options for grouping and aggregating the data. In that regard, pivoting this data can involve using at least one field to group it and applying at least one aggregation. A user can preview what the transformed data will look like. For instance, the user might wish, as shown in the example in FIG. 10, to group the data by customer_ID and calculate the sum of products each customer purchased.

Other aggregations may be used (e.g., number of sales for each product and its average price). Alternatively, the user might want to look at the behavior of individual customers and calculate how much each customer spent in total and how many different categories of products they purchased. For another alternative, the user might want to take the currencies or geographies into consideration. The user can come up several interesting ways they can transform and interpret this data.

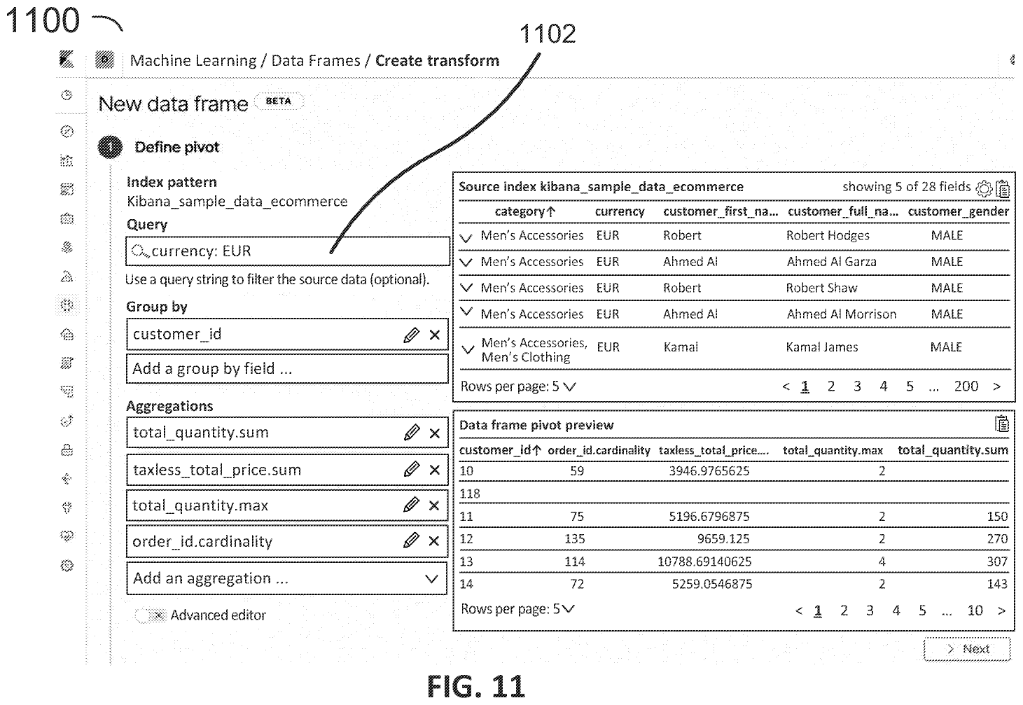

In some embodiments, more aggregations can be added in this example, e.g., to learn more about our customers' orders. For example, calculation can be made of the total sum of their purchases, the maximum number of products that they purchased in a single order, and their total number of orders. This can be configured by using the sum aggregation on the taxless_total_price field, the max aggregation on the total_quantity field, and the cardinality aggregation on the order_id field as shown in the example in FIG. 11.

In this example in FIG. 11, a query element 1102 is provided, e.g., for use if the user is interested in a subset of the data. In this example, the data is filtered so that the user is only looking at orders with a currency of EUR. Alternatively, data could also be grouped by that field too. If a user wants to use more complex queries, they can create their transform from a saved search.

Although the terms “data frame” and “new data frame” appear in certain figures, this term can be replaced by transform as used herein.

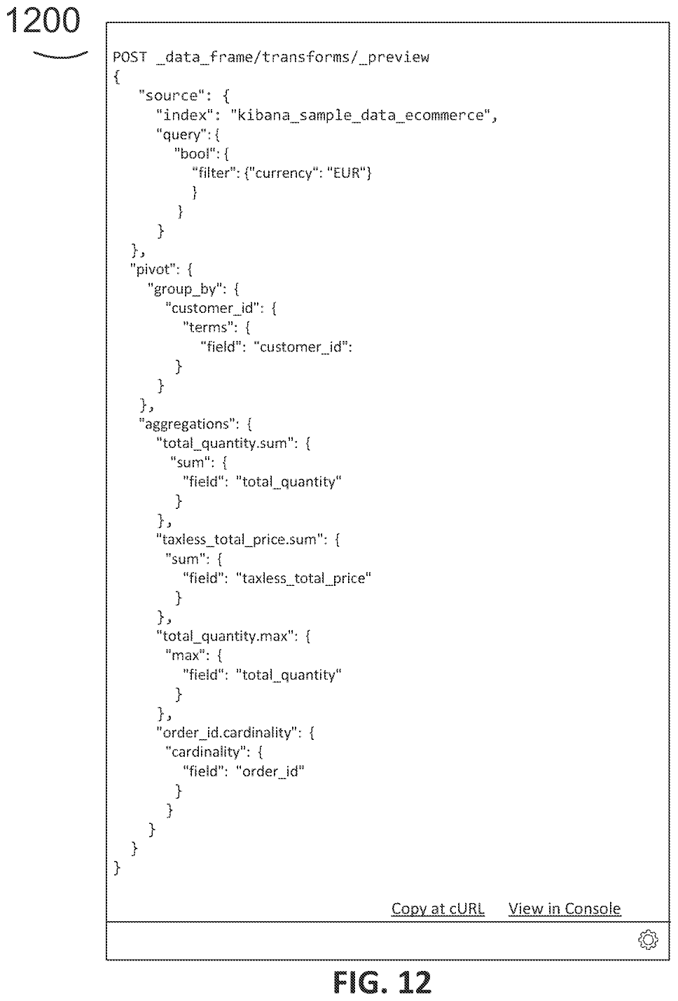

The preview transforms API can also be used to filter the data using a query term such as “Euro”. FIG. 12 shows an example for this and is expressed in JavaScript Object Notation (JSON). Other ways of expressing this may be used.

When the user is satisfied with the preview (either by UI or API), the user can create the transform, according to various embodiments. For example, the user can supply a job ID and the name of the target (or destination) index. In various embodiments, if the target (or destination) index does not exist, it will be created automatically. The user can then decide whether they want the transform to run once or continuously. For sample data in the figures, a default behavior can be used where the transform is just run once.

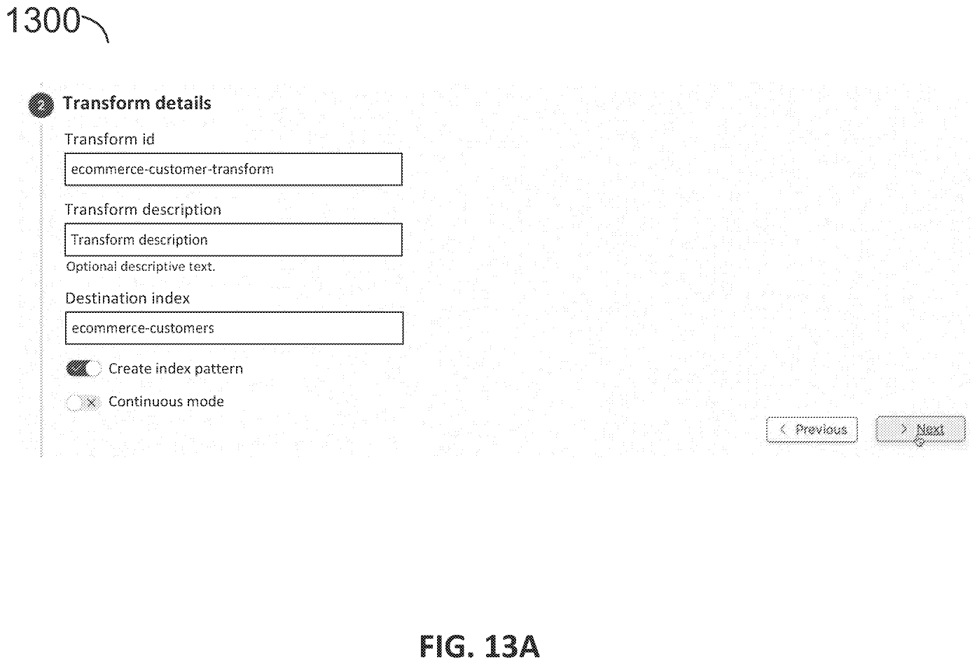

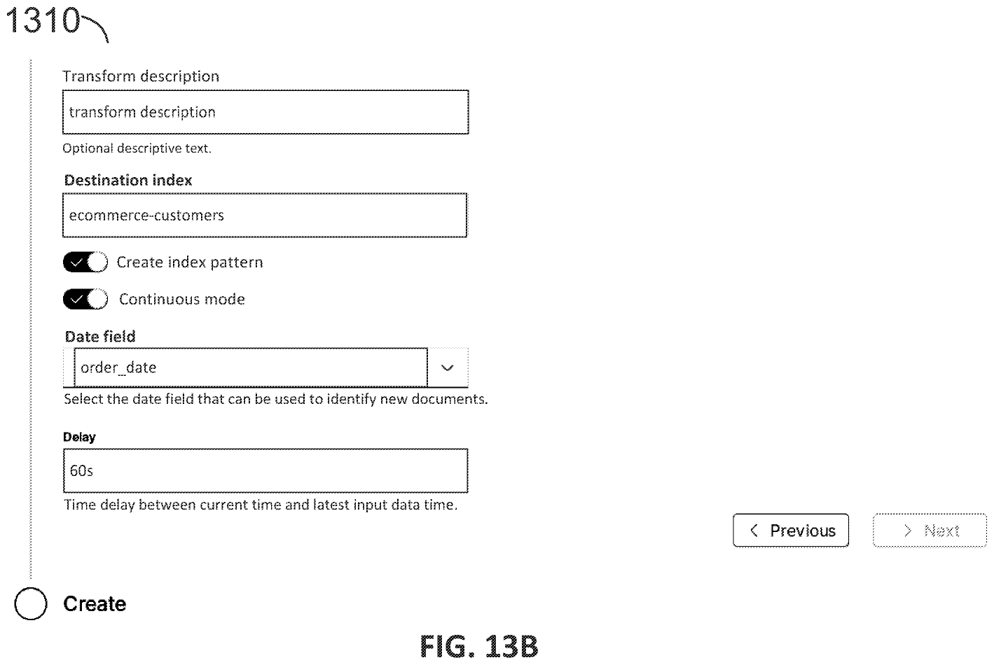

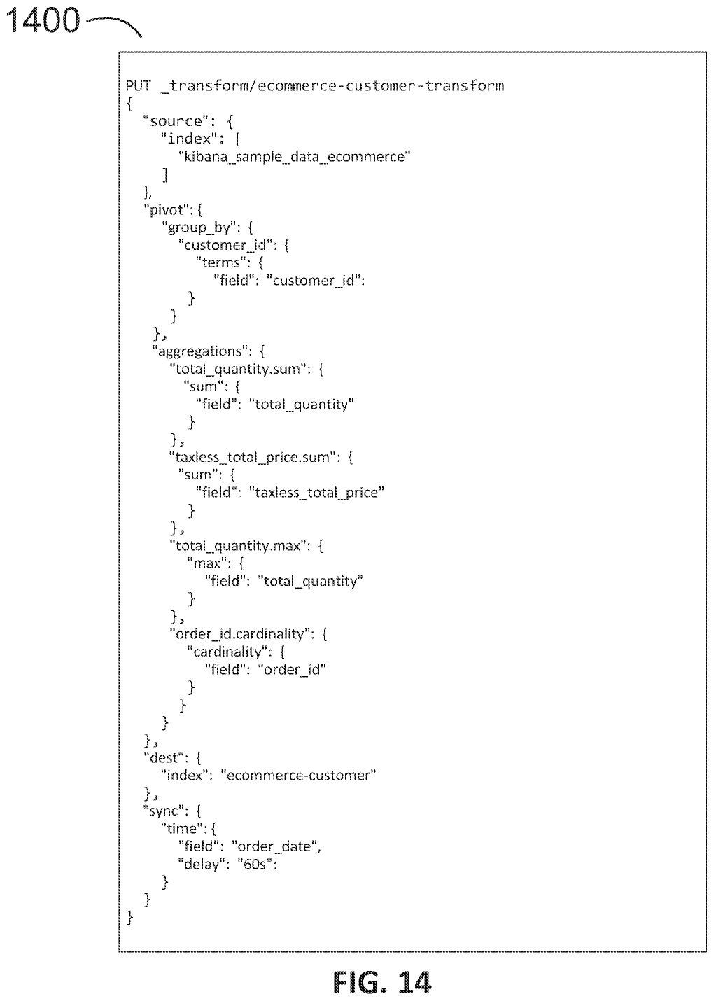

Since this sample data index is unchanging, the default behavior can be used and the transform run just once. FIG. 13A shows a UI 1300 which provides the option to enable the user to choose to run the transform in continuous (near real time, time series data) mode. In some embodiments, for continuous mode, the user must choose a field that the transform can use to check which entities have changed, e.g., ingetst_timestamp or order_date fields to name just a few. FIG. 13B illustrates an example UI 1310 for configuring the continuous mode. In some embodiments, a create transforms API can be used instead of the UI discussed above. FIG. 14 illustrates an example for the create transforms API.

In various embodiments, data in the destination index utilized or created by the transform can be explored using tools for such indices. FIG. 15 illustrates an example UI for exploring the composite aggregation data in the destination index.

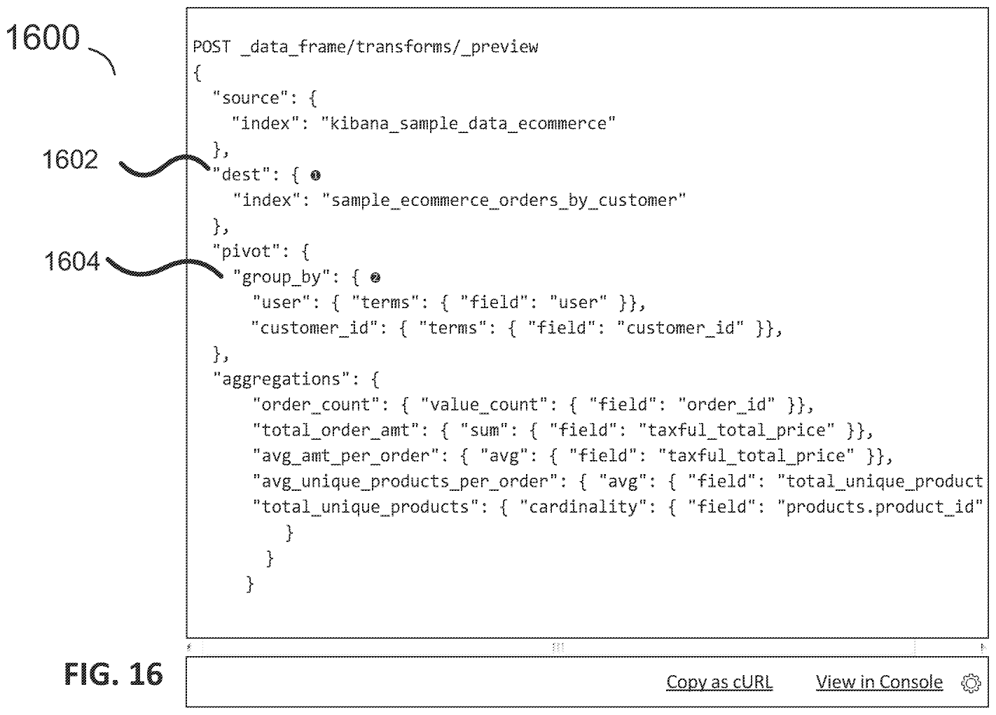

In another hypothetical webshop example of the use of transforms to enable a user to derive very customized and useful insights from their data. In this example, an orders dataset can be used to find the customers who spent the most in our hypothetical webshop. In that regard, the data can be transformed such that the destination index contains the number of orders, the total price of the orders, the amount of unique products and the average price per order, and the total amount of ordered products for each customer. FIG. 16 illustrates an example transforms preview API 1600 for an example use case for finding customers who spent the most in a hypothetical webshop. In example screenshot 1600 the destination index for the transform is identified as 1602 (and a highlighted 1), and since this is just an example preview the destination index can be ignored. In this example, two group_by fields have been selected and are identified at 1604 (and highlighted as 2). This grouping means the transform will contain a unique row per user and customer_id combination in this example. Within this dataset both these fields in this example are unique. The inclusion of both in the transform can provide more context to the final results. In example screenshot 1600 condensed JSON formatting has been used for easier readability of the pivot object. As compared to the example in FIG. 12, this example in FIG. 16 has no query, the grouping in FIG. 12 was just by customer_id, and FIG. 16 is in condensed JSON formatting.

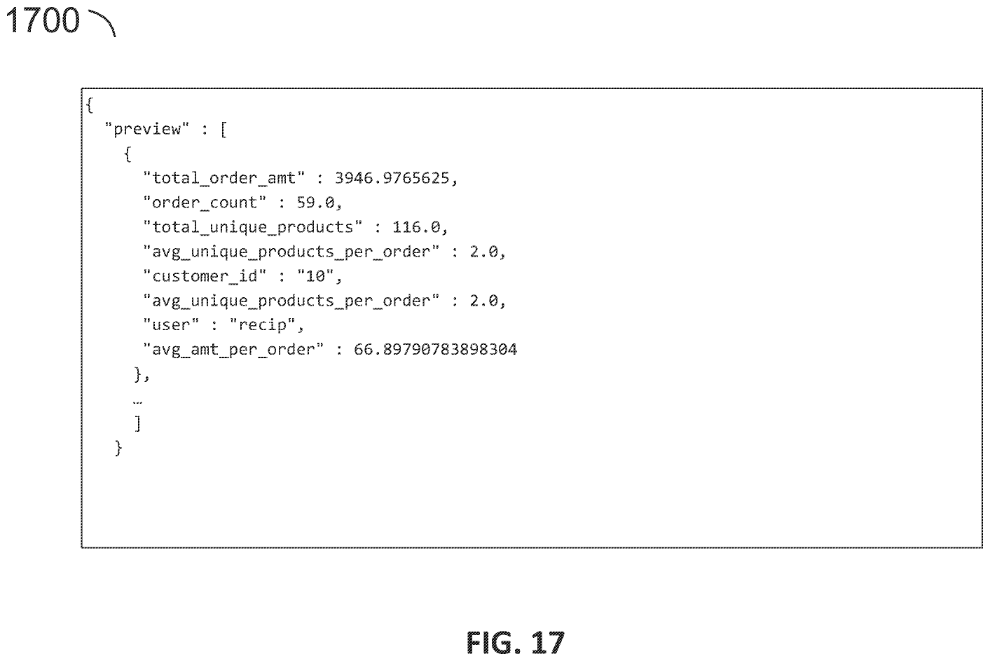

FIG. 17 illustrates an example view 1700 which provides for seeing the layout of the transform in advance, enabled by the example previews API (e.g., in FIG. 16). This view 1700 is populated with some sample numeric values. The transform in regard to the examples in FIG. 16 and FIG. 17 facilitates the user getting insights such as for example which customers spend the most, which customers spend the most per order, which customers order most often, and which customers ordered the least number of different products. Although aggregations in some embodiments are less efficient, more complex and burdensome for creating visualizations for example, it might be theoretically possible to answer these questions using aggregations. In addition to their other advantages, transforms in various embodiments allow a user to persist this data as a customer centric index. In various embodiments, this persistence enables a user to analyze data at scale and provides substantially more flexibility to explore and navigate data from a customer centric perspective. In some cases, the use of transforms makes creating visualizations substantially simpler for the user.

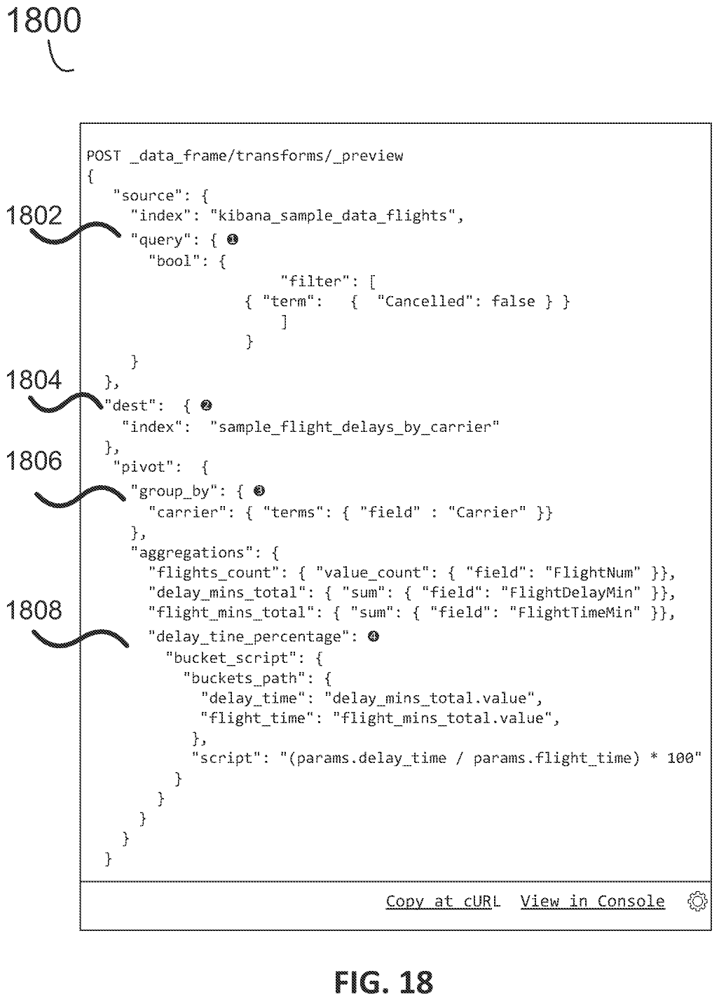

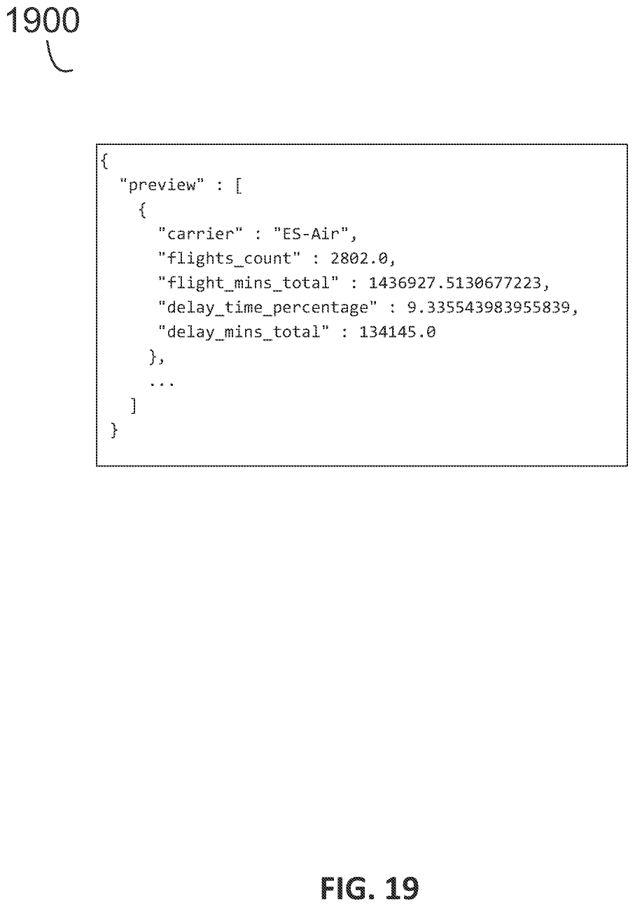

FIG. 18 illustrates a screenshot 1800 of a transform preview concerning an example use case regarding finding air carriers with the most delays. In this example, a flights sample dataset was used to find out which air carrier had the most delays. First, as shown at 1802 (and at 1), the source data is filtered such that it excludes all the cancelled flights by using a query filter. In this example the destination index for the transform is identified at 1804 (and at 2), but since this is just a preview the destination index can be ignored. The data is grouped by the carrier field shown at 1806 (and at 3) in this example which contains the airline name. The data is transformed to contain the distinct number of flights, the sum of delayed minutes, and the sum of the flight minutes by air carrier in this example. In general, a bucket_script can be used to perform calculations on the results that are returned by the aggregation. In this particular example, a particular bucket_script, see 1808 (and at 4), calculates what percentage of travel time was taken up by delays. As shown in the example screenshot 1900 in FIG. 19, the transform preview can also show a user that the new destination index could contain data values (like that shown) for each air carrier. For this sample data set, this transform makes it much easier for a user to answer questions such as which air carrier has the most delays as a percentage of flight time.

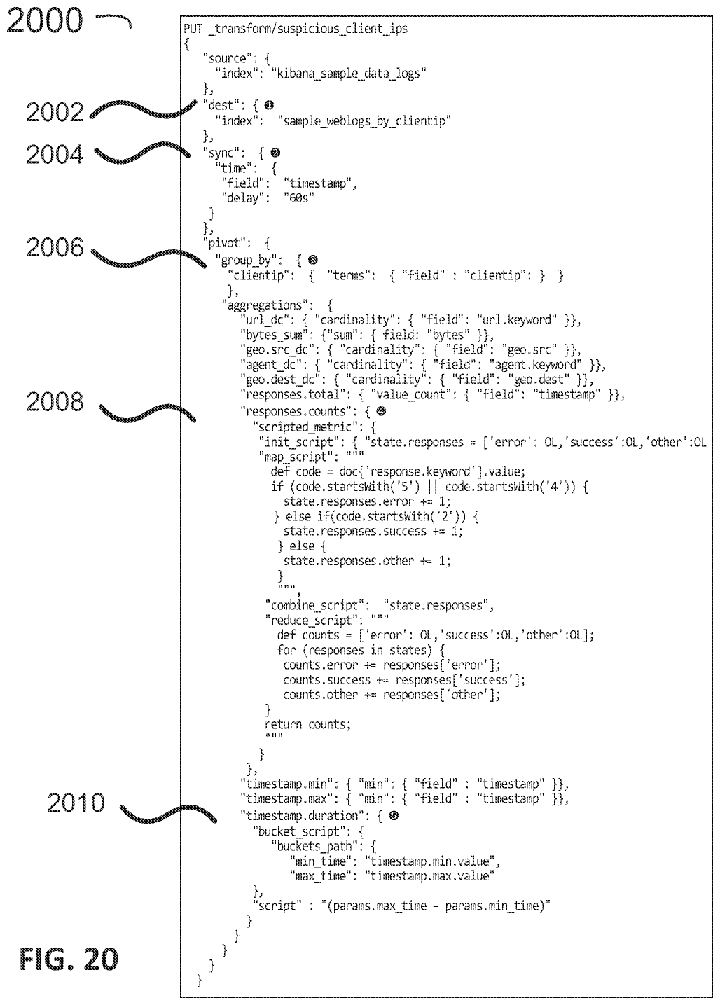

In various embodiments, with transforms, scripts can be used on a user's data. These transforms using scripts are flexible and can make it possible to perform very complex processing. One example uses scripted metrics to identify suspicious client IPs in the web log sample dataset. The data is transformed such that the new index contains the sum of bytes and the number of distinct URLs, agents, incoming requests by location, and geographic destinations for each client IP. Scripted field can also be used to count the specific types of HTTP responses that each client IP receives. Ultimately, the example as illustrated in FIG. 20 transforms web log data into an entity centric index where the entity is clientip.

FIG. 20 illustrates a screenshot 2000 of a transform preview concerning an example use case regarding finding suspicious client IPs by using scripted metrics. In this example, a sample dataset was used. As shown at 2002 (see portion identified as 1 in FIG. 20), a destination “dest” index is specified. The transform in the example for FIG. 20 is configured to run continuously. As shown at 2004 (see “sync” in portion identified at 2 in FIG. 20), this example used the timestamp field to synchronize the source and destination indices.

In the example in FIG. 20, the data is grouped by the clientip field shown at 1806 (and as 3) in this example. A scripted metric at 2008 (also near portion identified as 4 in FIG. 20) performs a distributed operation on the web log data to count specific types of HTTP responses (error, success, and other) in this example. In this example, a particular bucket_script, see 2010 (also near portion identified as 5), calculates the duration of the clientip access based on the results of the aggregation.

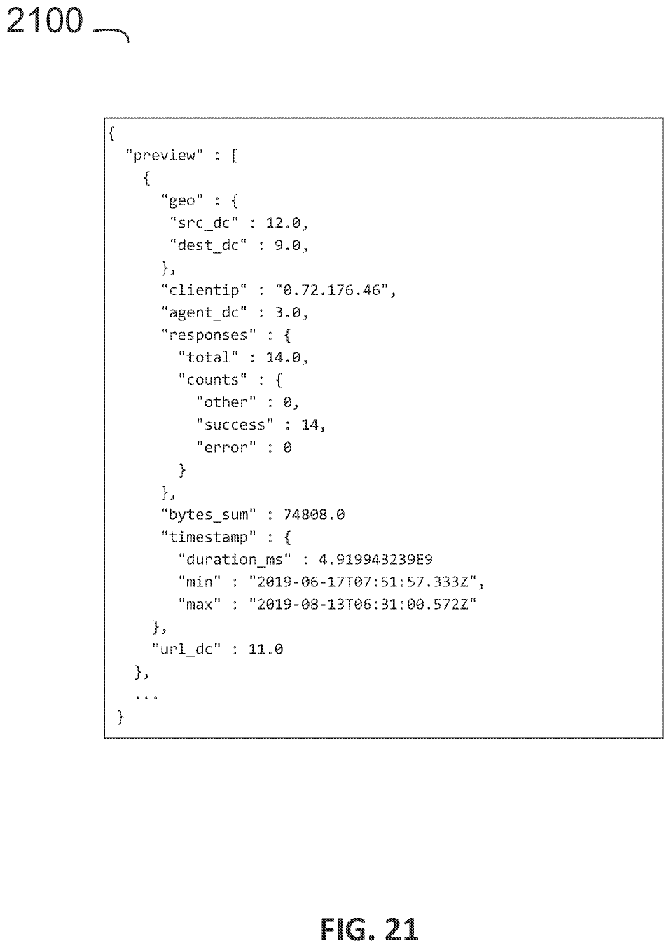

As shown in the example screenshot 2100 in FIG. 21, the transform preview can also shows a user that the new destination index could contain data values like this for each clientip. This particular transform in this example makes it much easier for a user to answer questions such as which client IPs are transferring the most amounts of data, which client IPs are interacting with a high number of different URLs, which client IPs have high error rates, and which client IPs are interacting with a high number of destination countries, for instance.

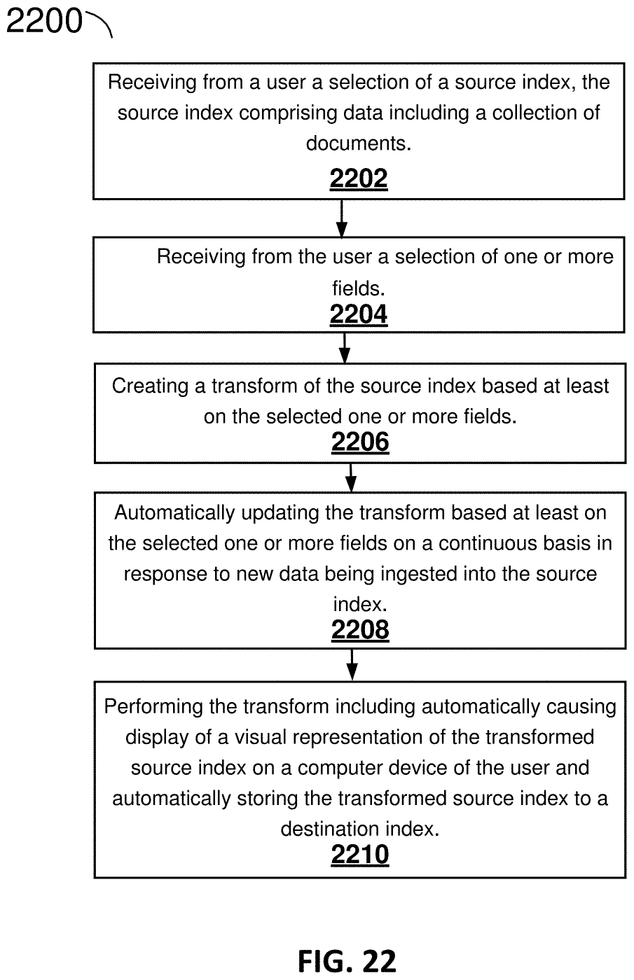

FIG. 22 is a simplified flow diagram of a method 2200, according to an example embodiment.

Operation 2202 includes receiving from a user a selection of a source index, the source index comprising data including a collection of documents, as described further herein.

In operation 2204, the example method further includes receiving from the user a selection of one or more fields, as described further herein.

In operation 2206, the example method further includes creating a transform of the source index based at least on the selected one or more fields, as described further herein.

In operation 2208, the example method further includes automatically updating the transform based at least on the selected one or more fields on a continuous basis in response to new data being ingested into the source index, as described further herein.

In operation 2210, the example method further includes performing the transform including automatically causing display of a visual representation of the transformed source index on a computer device of the user.

Operation 2210 also includes automatically storing the transformed source index to a destination index, as described further herein. Transforms can be used to pivot a user's indexed data into a new entity-centric index.

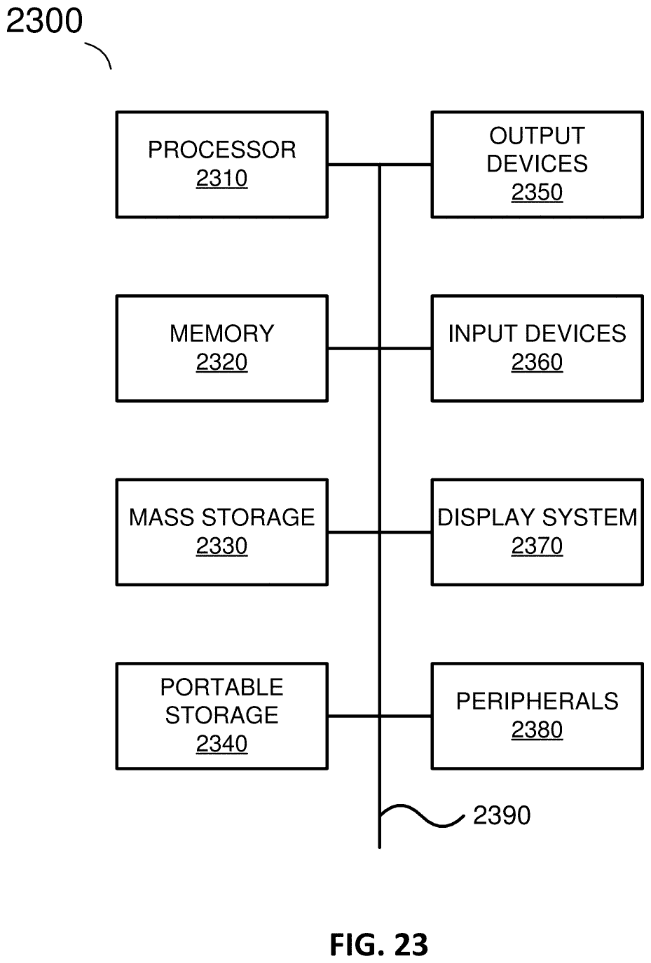

FIG. 23 illustrates an exemplary computer system 2300 that may be used to implement some embodiments of the present invention. The computer system 2300 in FIG. 23 may be implemented in the contexts of the likes of computing systems, networks, servers, or combinations thereof. The computer system 2300 in FIG. 23 includes one or more processor unit(s) 2310 and main memory 2320. Main memory 2320 stores, in part, instructions and data for execution by processor unit(s) 2310. Main memory 2320 stores the executable code when in operation, in this example. The computer system 2300 in FIG. 23 further includes a mass data storage 2330, portable storage device 2340, output devices 2350, user input devices 2360, a graphics display system 2370, and peripheral device(s) 2380.

The components shown in FIG. 23 are depicted as being connected via a single bus 2390. The components may be connected through one or more data transport means. Processor unit(s) 2310 and main memory 2320 are connected via a local microprocessor bus, and the mass data storage 2330, peripheral device(s) 2380, portable storage device 2340, and graphics display system 2370 are connected via one or more input/output (I/O) buses.

Mass data storage 2330, which can be implemented with a magnetic disk drive, solid state drive, or an optical disk drive, is a non-volatile storage device for storing data and instructions for use by processor unit(s) 2310. Mass data storage 2330 stores the system software for implementing embodiments of the present disclosure for purposes of loading that software into main memory 2320.

Portable storage device 2340 operates in conjunction with a portable non-volatile storage medium, such as a flash drive, floppy disk, compact disk, digital video disc, or Universal Serial Bus (USB) storage device, to input and output data and code to and from the computer system 2300 in FIG. 23. The system software for implementing embodiments of the present disclosure is stored on such a portable medium and input to the computer system 2300 via the portable storage device 2340.

User input devices 2360 can provide a portion of a user interface. User input devices 2360 may include one or more microphones, an alphanumeric keypad, such as a keyboard, for inputting alphanumeric and other information, or a pointing device, such as a mouse, a trackball, stylus, or cursor direction keys. User input devices 2360 can also include a touchscreen. Additionally, the computer system 2300 as shown in FIG. 23 includes output devices 2350. Suitable output devices 2350 include speakers, printers, network interfaces, and monitors.

Graphics display system 2370 include a liquid crystal display (LCD) or other suitable display device. Graphics display system 2370 is configurable to receive textual and graphical information and processes the information for output to the display device. Peripheral device(s) 2380 may include any type of computer support device to add additional functionality to the computer system.

Some of the components provided in the computer system 2300 in FIG. 23 can be those typically found in computer systems that may be suitable for use with embodiments of the present disclosure and are intended to represent a broad category of such computer components. Thus, the computer system 2300 in FIG. 23 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including MAC OS, UNIX, LINUX, WINDOWS, ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computing system 2300 may be implemented as a cloud-based computing environment, such as a virtual machine operating within a computing cloud. In other embodiments, the computing system 2300 may itself include a cloud-based computing environment, where the functionalities of the computing system 2300 are executed in a distributed fashion. Thus, the computing system 2300, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computing system 2300, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, e.g., optical, magnetic, and solid-state disks, such as a fixed disk. Volatile media include dynamic memory, such as system random-access memory (RAM). Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, e.g., a floppy disk, a flexible disk, a hard disk, magnetic tape, any other magnetic medium, a CD-ROM disk, digital video disk (DVD), any other optical medium, any other physical medium with patterns of marks or holes, a RAM, a programmable read-only memory (PROM), an erasable programmable read-only memory (EPROM), an electrically erasable programmable read-only memory (EEPROM), a Flash memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as PYTHON, JAVASCRIPT, JAVA, SMALLTALK, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

1. A computer-implemented method for creating and performing transforms of indexed data on a continuous basis, the method comprising:
receiving from a user a selection of a source index file, the source index file comprising data consisting of a collection of documents;
receiving from the user a selection of one or more fields;
creating a transform of the source index file based at least on the selected one or more fields and performing the transform to generate a destination index file; and
automatically updating the destination index file on a continuous basis based on the transform with new data being ingested into the source index file,
wherein the transform includes
automatically causing display of a visual representation of the destination index file on a computer device of the user.

2. The computer-implemented method of claim 1, wherein the destination index file being an entity-centric index updated on a continuous basis with the new data, the destination index file being different than the source index file.

3. The computer-implemented method of claim 2, wherein the selection of the one or more fields defines a pivot wherein the transform is configured so as to pivot the data in the source index file, thereby generating an entity-centric index.

4. The computer-implemented method of claim 1, further comprising creating a checkpoint when the transform is updated based on the ingested new data.

5. The computer-implemented method of claim 1, wherein the transforms operates across an entirety of the data of the source index file.

6. The computer-implemented method of claim 1, further comprising receiving a query from the user, and in response to receiving the query, limiting scope of the created transform based on the query.

7. The computer-implemented method of claim 1, wherein at least some of the one or more fields are categorical field comprising terms.

8. The computer-implemented method of claim 1, wherein at least some of the one or more fields are numerical field comprising numeric values.

9. The computer-implemented method of claim 1, further comprising receiving a time interval from the user, wherein values of the numerical fields are bucketed using the time interval.

10. The computer-implemented method of claim 1, wherein the source index file data comprises a collection of documents having similar characteristics, the source index file being identified by a name.

11. The computer-implemented method of claim 1, further comprising in response to a user selection, generating a preview of the transformed source index file for the user prior to storing the transformed source index in the destination index file.

12. The computer-implemented method of claim 1, wherein the source index file comprises a plurality of indices, and the destination index file comprises one or more indices.

13. The computer-implemented method of claim 1, further comprising providing a user interface for receiving at least the selection from the user.

14. The computer-implemented method of claim 1, further comprising providing an application program interface (API) for instantiating the transform.

15. The computer-implemented method of claim 14, wherein the API is configured for specifying the source index file, the one or more fields, for creating and updating the transform and for storing the transformed index to the destination index file.

16. The computer-implemented method of claim 1, wherein an analytics and visualization platform is used to generate the visual representation, the visual representation has features including a histograms, line graph, or pie chart and the analytics including time-series data analytics and analytics.

17. The computer-implemented method of claim 1, wherein a machine learning model is created based on the transform of the source index file wherein behaviors are captured across an entirety of a user base of two or more users.

18. The computer-implemented method of claim 1, further comprising:
receiving from the user a selection of a type of aggregation;
creating a transform of the source index file based at least on the selected one or more fields and the selected type of aggregation, wherein the selected type of aggregation is a sum aggregation, a max aggregation, or a cardinality aggregation;
automatically updating the transform based at least on the selected one or more fields and the selected type of aggregation on a continuous basis based on the transform with new data being ingested into the source index file; and
the performing the transform further comprising:
automatically causing display of the visual representation of the composite aggregation on the computer device of the user; and
automatically storing the composite aggregation to the destination index file.

19. A system, comprising:
a processor; and
a memory, the processor executing instructions stored in the memory to:
receive from a user a selection of a source index file, the source index file comprising data consisting of a collection of documents;
receive from the user a selection of one or more fields;
create a transform by the processor of the source index file based at least on the selected one or more fields and perform the transform to generate a destination index file; and
automatically update the destination index file on a continuous basis based on the transform with new data being ingested into the source index file,
wherein the transform includes,
automatically causing display of a visual representation of the destination index file index on a computer device of the user.

20. A non-transitory computer readable medium having embodied thereon a program, the program being executable by a processor for performing a method for:
receiving from a user a selection of a source index file, the source index file comprising data consisting of a collection of documents;
receiving from the user a selection of one or more fields;
creating, by the processor, a transform of the source index file based at least on the selected one or more fields and performing the transform to generate a destination index file; and
automatically updating the destination index file on a continuous basis based on the transform with new data being ingested into the source index file,
wherein the transform includes
automatically causing display of a visual representation of the destination index file on a computer device of the user.
